(19) United States
(12) Patent Application Publication
(10) Pub. No.: US 2024/0093522 A1
(43) Pub. Date: Mar. 21, 2024

(54) DOCKING SYSTEM WITH CAMERA FOR AUTOMATIC SWIMMING POOL CLEANER

(71) Applicant: ZODIAC POOL CARE EUROPE, Belberaud (FR)

(72) Inventors: Hendrikus Johannes van der Meijden, Midrand (ZA); Rémi Deloche, Toulouse (FR); Dustin Borg, Poway, CA (US); Mehdi Chafik, Tournefeuille (FR); Mark Bauckman, San Marcos, CA (US); E. Keith McQueen, Vista, CA (US)

(73) Assignee: ZODIAC POOL CARE EUROPE, Belberaud (FR)

(21) Appl. No.: 18/368,542

(22) Filed: Sep. 14, 2023

Related U.S. Application Data
(60) Provisional application No. 63/413,408, filed on Oct. 5, 2022.
(60) Provisional application No. 63/406,821, filed on Sep. 15, 2022.

(51) Int. Cl. E04H 4/16; G06T 7/70

(52) U.S. Cl. CPC E04H 4/1654; G06T 7/70

(57) ABSTRACT

A docking system for an automatic swimming pool cleaner includes a dock and an underwater-facing camera. The underwater-facing camera ay be provided to monitor the automatic swimming pool cleaner underwater. A method of controlling an automatic swimming pool cleaner may include using information obtained from a camera on a dock of a docking system to control the automatic swimming pool cleaner.

### REFERENCE TO RELATED APPLICATION

This application claims the benefit of U.S. Provisional Patent Application No. 63/413,408, filed on Oct. 5, 2022, and entitled DOCKING SYSTEM WITH CAMERA FOR AUTOMATIC SWIMMING POOL CLEANER, and the benefit of U.S. Provisional Patent Application No. 63/406,821, filed on Sep. 15, 2022, and entitled DOCKING SYSTEM FOR AUTOMATIC SWIMMING POOL CLEANER, both of which are hereby incorporated by reference in their entireties.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. While various types of information may be useful for the APC and/or may be desirable to communicate to a user, traditional APCs cannot integrate all sensors due to size constraints on the APC as well as constraints on the sensors such as fragility of the sensor, type of sensor, costs associated with sensors and/or integrating such sensors on an APC, operating environment constraints, etc.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a docking system for an APC includes a dock with an underwater-facing camera which may monitor the APC underwater.

According to various embodiments, a docking system for an APC includes a dock with a camera, and the docking system may identify a location of the APC within a swimming pool or spa based on data from the camera.

According to certain embodiments, a docking system for an APC includes a camera on a dock. The camera may detect the APC within a target area and send a location of the APC within the target area based on the detection of the APC by the camera.

According to some embodiments, a method of controlling an APC includes using information from a camera on a dock of a docking system to control the APC.

According to some embodiments, a method includes monitoring an APC underwater using a camera on a dock of a docking system.

According to various embodiments, a docking system for an APC includes (i) a camera for gathering visual information about the APC within a swimming pool or spa and (ii) a sensor for gathering non-visual information. In some embodiments, the visual and non-visual information is used to control the APC.

According to certain embodiments, a docking system for an APC includes a camera for monitoring a target area within a swimming pool or spa. The docking system may (i) identify a location of the APC within the target area based on a detection of the APC within the target area using the camera and (ii) send location information to the APC based on the detection using the camera.

According to various embodiments, a docking system for an APC includes a location communicator on a dock, and the location communicator may provide location information to the APC within a swimming pool or spa.

According to certain embodiments, a docking system includes (i) an APC with a location communicator and (ii) a dock with a camera which may monitor the APC by detecting at least the location communicator.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a docking system for an APC according to embodiments.

FIG. 2 illustrates a docking system for an APC according to embodiments.

FIG. 3 is another view of the docking system of FIG. 2.

### DESCRIPTION OF THE INVENTION

Described herein are docking systems for APCs with one or more sensors for gathering information about and/or relevant to the APC and/or equipment for the swimming pool or spa. The docking systems described herein may also communicate such gathered information to the APC and/or to a user using various techniques as desired. The information gathered by the docking systems described herein advantageously may be used to control the APC and/or other equipment associated with the swimming pool or spa. Various other benefits and advantages may be realized with the devices and methods provided herein, and the aforementioned advantages should not be considered limiting.

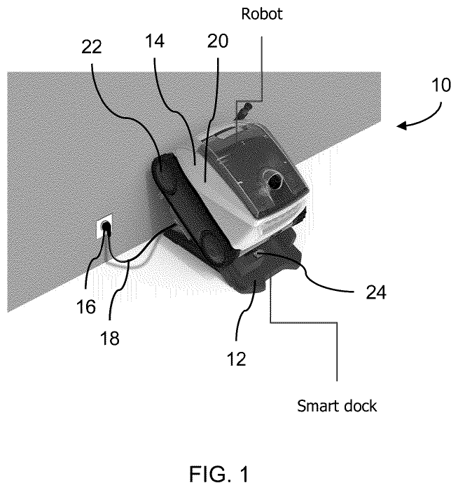

FIG. 1 illustrates an example of a docking system 10 according to embodiments. The docking system 10 includes a dock 12, and an APC 14 may be supported on the dock 12.

The APC 14 generally includes a body 20 and one or more motive elements 22 (e.g., wheels, tracks, feet, etc.). A pump, filter assembly, cleaning device such as a brush assembly or other suitable device, any suitable electric or other motors, a controller (e.g., processor and memory), a communication module, an on-board power source (e.g., rechargeable batteries), and/or various other features may be provided on or within the APC 14 as desired. The APC 14 may be various types of APCs as desired, and the particular APC 14 illustrated should not be considered limiting. Other non-limiting examples of APCs 14 may include those described in U.S. Pat. Nos. 10,316,534, 9,488,154, 8,578,538, and U.S. Patent Publication No. 2014/0303810, all of which are hereby incorporated by reference in their entireties.

The dock 12 optionally may include one or more electrical contacts (not shown) for selectively charging or re-charging a battery of the APC 14 as desired and based on contact between the APC 14 and the electrical contacts. The dock 12 may instead or additionally be capable of charging the APC 14 via inductive charging. In such embodiments, the docking system 10 may be a charging system. Optionally, and as illustrated in FIG. 1, the dock 12 may be connected to a power source 16 via a cord 18 or other suitable mechanism or device. In other embodiments, the docking system 10 includes means for generating electricity via renewable energy, and/or the docking system 10 may be a self-powered docking system. As a non-limiting example, the docking system 10 may include a solar panel for generating electricity on the dock 12 and/or otherwise associated with the dock 12. In other embodiments, the docking system 10 need not charge the APC 14 and may just support the APC 14 while not in use and/or as otherwise desired.

In various embodiments, the dock 12 includes one or more sensors 24. Optionally, the dock 12 includes a controller (processor and/or memory) and/or a communication module.

The one or more sensors 24 may be provided at various locations on and/or relative to the dock 12 as desired. The one or more sensors 24 may be various types of sensors as desired for gathering information about and/or relevant to the APC and/or equipment for the swimming pool or spa. As some non-limiting examples, the one or more sensors 24 may be various types of water sensors, including but not limited to oxidation-reduction potential (ORP) sensors, pH sensors, temperature sensors, conductivity sensors, salinity sensors, combinations thereof, and/or other types of water sensors as desired. In such embodiments, the water sensors may analyze water released by the APC 14 after a cleaning cycle and/or may analyze the water of the pool itself if the dock 12 is installed within a portion of the pool or spa. As another non-limiting example, the one or more sensors 24 may be weight sensors such as a scale, and the one or more sensors 24 may measure weight variation of the cleaner (e.g., to determine a quantity of debris extracted from the pool, etc.). As yet another non-limiting example, the one or more sensors 24 may be a geolocation sensor (e.g., a global positioning system sensor, etc.) for facilitating a determination of location of the docking system 10. In another non-limiting example, the one or more sensors 24 may be environmental sensors such as wind sensors, temperature sensors, rain sensors, etc. providing information about environmental conditions in which the docking system 10 is provided. In a further non-limiting example, the one or more sensors 24 may be a sensor for the means for generating electricity via renewable energy. As an example, the one or more sensors 24 may be luminosity sensors if the dock 12 includes the solar panel. In another example as described in more detail below, the one or more sensors 24 may be an optical sensor such as a camera. The aforementioned sensors 24 are for illustrative purposes only and should not be considered limiting, and in other embodiments, other types of sensors and/or combinations of sensors may be used as desired.

The information gathered by the one or more sensors 24 of the docking system 10 may be communicated using various techniques as desired. In one non-limiting example, the docking system 10 may communicate the information to the APC 14 based on electrical contact between the APC 14 and the dock 12 (e.g., via the electrical contacts) and using a suitable communication protocol (e.g., UART, LIN, etc.). Additionally or alternatively, the dock 12 may wirelessly communicate (e.g., Bluetooth, WiFi, LiFi, LIDAR, etc.) using the communication module. In such embodiments, the dock 12 may wirelessly communicate with the APC 14, other equipment for the swimming pool or spa, and/or to an external device (e.g., personal electronic device, smartphone, etc.). Additionally or alternatively, the docking system 10 includes an interface device for receiving and/or providing information. Non-limiting examples of interface devices include lights, mechanical buttons, switches, screens, speakers, combinations thereof, and/or other human machine interfaces as desired.

The information gathered by the docking system 10 may be used for various processes as desired. In some embodiments, the information may be communicated by the docking system 10 to the APC 14 or other equipment for controlling the APC 14 or other equipment. As a non-limiting example, the APC 14 may receive the information gathered by the one or more sensors 24, and the APC 14 may adapt its cleaning cycles based on such information. Additionally or alternatively, the information may be communicated by the docking system 10 to a user for informational, diagnostic, and/or other uses as desired. As a non-limiting example, the docking system 10 may communicate a sensed water temperature level to the user such that the user can adjust temperature settings of the swimming pool or spa as desired. As another non-limiting example, the docking system 10 may communicate a sensed water temperature level to a controller such that the controller can control a heater of the swimming pool or spa to reach a predetermined or preset water temperature level if the sensed water temperature level is below the predetermined water temperature level. As another example, as described below, the docking station 10 may use a camera or other optical sensor to communicate the position of the APC 14 within the pool. Various other processes and methods may use the information gathered by the docking system 10, and the aforementioned examples should not be considered limiting.

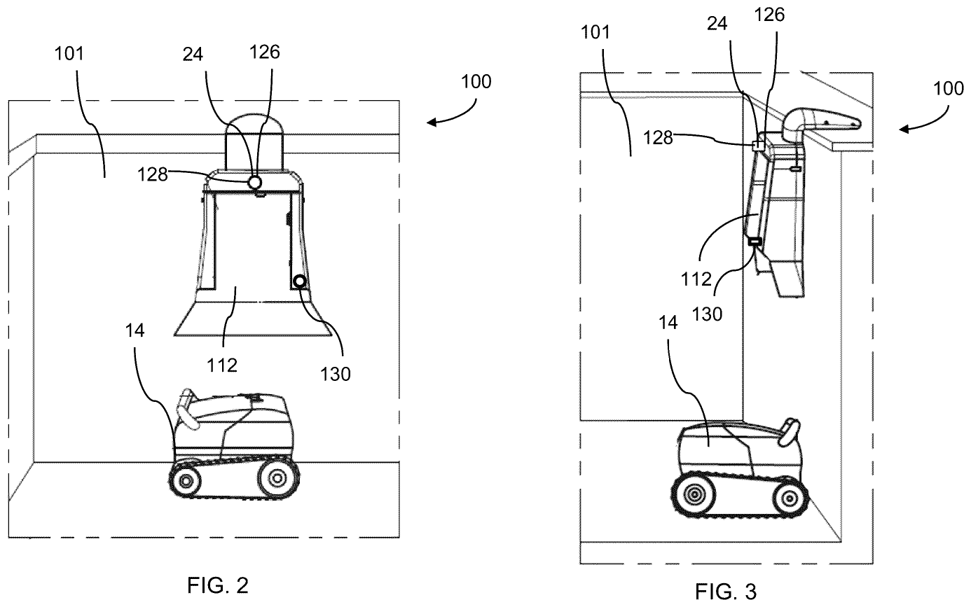

FIGS. 2 and 3 illustrate another example of a docking system 100 with a dock 112 for the APC 14. Compared to the dock 12, the dock 112 is positionable such that at least a portion of the dock 112 extends into the water of a swimming pool or spa 101. In such embodiments, the dock 112 optionally is supported on an edge of the swimming pool 101 and/or as otherwise desired, including on a float or other component.

Similar to the dock 12, the dock 112 includes one or more sensors 24. The dock 112 may also include one or more location communicators, such as a light source. In the embodiment illustrated, the sensor 24 includes a visual sensor 126, such as but not limited to a camera 128. In certain embodiments, the camera 128 is an underwater and/or an under-water facing camera 128 capable of obtaining visual images of at least a portion of a surface of the pool 101 (hereinafter “target area”). In other embodiments, the camera 128 may be provided at other locations on the dock 112 (and/or the dock 12) as desired suitable for obtaining visual images of other target areas of a pool in which an APC 14 moves. The camera may be various types of cameras or imaging devices as desired capable of obtaining visual images of at least a portion of the surfaces of the pool 101 and/or other locations in which the APC 14 moves. Non-limiting examples of cameras may include optical or video cameras, single or multi-stereo-cameras, RGB-D cameras, infrared cameras, UV cameras, combinations thereof, or otherwise as desired. Other types of sensors 24 may be utilized with the dock 112 as desired. Moreover, in certain embodiments, the dock 12 may include the visual sensor 126 and/or the camera 128.

In certain embodiments, the camera 128 (and/or other visual sensor 126 on the dock 112) is configured to monitor and/or detect the APC 14 within the field of view of the camera 128. In various embodiments, based on the detected APC 14, the controller of the docking system 100 may determine the position of the APC 14 within the pool 101, and the determined position may be communicated to the APC 14 or to an external device (e.g., using wireless communication, light communication, LIDAR, time of flight information, other communication techniques or combinations of techniques, etc.). In the example of FIGS. 2 and 3, the dock 112 additionally or alternatively includes a light source 130, which can be used to communicate with the APC 14 and/or provide a base location for the APC 14 to reference when cleaning the pool 101. In certain embodiments, a characteristic of the light source 130 (or other suitable location communicator) may be actively controlled to communicate location information to the APC 14. As non-limiting examples, a color, intensity, frequency, pattern, etc. of light emitted by the light source 130 may be controlled based on the determined location of the APC 14, and the APC 14 may use the control of such characteristics to ascertain its location within the pool 101. Additionally, or alternatively, the light source 130 may remain substantially fixed or constant to provide a base location that may be used by the APC 14. As non-limiting examples, the APC 14 may detect the light emitted from the light source 130 and may use a detected change in brightness or other characteristic of the light to ascertain its location relative to the known location of the dock 112. As a non-limiting example, a decrease in brightness may be used by the APC 14 to determine that it is at a location remote from the dock 112, and a steadily increase in brightness may be used by the APC 14 to determine that its location relative to the dock 112 is decreasing.

In various embodiments, the dock 112 may be at a fixed location (e.g., a known location) relative to the pool 101, thereby allowing the controller to determine the location of the APC 14 in the pool 14. The location communicated to the APC 14 may be used by the APC 14 to perform various actions, such as cleaning the pool in an efficient manner. As a non-limiting example, the camera 128 on the dock 112 may detect the APC 14 within the pool 101 and communicate various information to the APC 14 about its detected location, such as a predicted or estimated distance of the APC 14 from the dock 112 and/or other structure or surface, a coordinate location of the APC 14 on the floor of the pool 101, a trend in movement of the APC 14 (e.g., approaching a wall, moving away from the dock 112, moving along a wall, etc.), and/or other location information as desired. The dock 112 having a camera 128 and/or another visual sensor and/or location communicator (e.g., such as the light source 130) provides the APC 14 with a base location that serves as static reference point when the APC 14 is cleaning the pool.

Optionally, the APC 14 may include one or more location communicators on the APC 14 itself, which may facilitate monitoring of the APC 14 by the camera 128 and/or determination of the location of the APC 14 using the camera 128. The location communicator(s) may be similar to those discussed previously, and in one non-limiting example the location communicator may be a light source on the APC 14. In such embodiments, the camera 128 may detect at least the location indicator on the APC 14 within a field of view of the camera 128, thereby allowing the camera 128 to monitor the APC 14 and estimate or determine a location of the APC 14 based on the location communicator. As a non-limiting example, because the dock 112 with the camera 128 may be at a fixed location, the camera 128 may use a detected change in characteristic of the location communicator to at least partially identify a location of the APC 14. As non-limiting examples, the docking system 110 may use a change in brightness and/or color of light emitted from the light source on the APC 14 to identify a location relative to the fixed location of the docking station 112.

In various embodiments, in addition to detecting the APC 14 using the data from the camera 128, information about the pool 101 may be identified using the camera 128. Such information optionally may be communicated to the APC 14 and/or to an external device to further improve a cleaning operation of the APC 14. As a non-limiting example, in addition to detecting the APC 14, the camera may detect debris within the pool 101. In such embodiments, the controller may determine a location of the debris relative to the dock 112 and/or generally within the pool 101 as well as the location of the APC 14. The location of the debris within the pool 101 may be communicated to the APC 14, and/or a relative location of the debris relative to the APC 14 may be determined and communicated to the APC 14.

Exemplary concepts or combinations of features of the invention may include:
A. A docking system for an APC, the docking system comprising a dock with an underwater-facing camera, wherein the underwater-facing camera is configured to monitor the APC underwater.
B. The docking system of any preceding or subsequent statement or combination of statements, further comprising a sensor in addition to the underwater-facing camera, wherein the sensor is configured to gather information about the APC and/or for controlling the APC or other equipment for a swimming pool or spa.
C. A docking system for an APC, the docking system comprising a dock with a camera, wherein the docking system is configured to identify a location of the APC within a swimming pool or spa based on data from the camera.
D. A docking system for an APC, the docking system comprising a camera on a dock, the camera configured to detect the APC within a target area and send a location of the APC within the target area based on the detection of the APC by the camera.
E. A method of controlling an APC, the method comprising using information from a camera on a dock of a docking system to control the APC.
F. A method comprising monitoring an APC underwater using a camera on a dock of a docking system.
G. The method of any preceding or subsequent statement or combination of statements, further comprising determining a location of the APC using data from the camera and communicating the location to the APC.
H. A docking system for an APC, the docking system comprising (i) a camera for gathering visual information about the APC within a swimming pool or spa and (ii) a sensor for gathering non-visual information, wherein the visual and non-visual information is used to control the APC.
I. The docking system of any preceding or subsequent statement or combination of statements, wherein the non-visual information comprises oxidation-reduction potential information, pH information, temperature information, conductivity information, and/or salinity information.
J. A docking system for an APC, the docking system comprising a camera configured to monitor a target area within a swimming pool or spa, wherein the docking system is configured to (i) identify a location of the APC within the target area based on a detection of the APC within the target area using the camera and (ii) send location information to the APC based on the detection using the camera.
K. A docking system for an APC, the docking station comprising a location communicator on a dock, wherein the location communicator is configured to provide location information to the APC within a swimming pool or spa.
L. The docking system of any preceding or subsequent statement or combination of statements, wherein the location communicator comprises a light source.
M. The docking system of any preceding or subsequent statement or combination of statements, wherein the location communicator is configured to provide location information based on a characteristic of the location communicator.
N. A docking system comprising (i) an APC comprising a location communicator and (ii) a dock comprising a camera, wherein the camera is configured to monitor the APC by detecting at least the location communicator.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A docking system for an automatic swimming pool cleaner (APC) includes a dock with an underwater-facing camera, wherein the underwater-facing camera is configured to monitor the APC underwater.

2. The docking system of claim 1, further comprising a sensor in addition to the underwater-facing camera, wherein the sensor is configured to gather information about the APC.

3. The docking system of claim 1, further comprising a sensor in addition to the underwater-facing camera, wherein the sensor is configured to gather non-visual information for controlling the APC or other equipment for a swimming pool or spa.

4. The docking system of claim 3, wherein the non-visual information comprises oxidation-reduction potential information, pH information, temperature information, conductivity information, and/or salinity information.

5. The docking system of claim 1, wherein the docking system is configured to identify a location of the APC within a swimming pool or spa based on data from the camera.

6. The docking system of claim 1, wherein the camera is configured to detect the APC within a target area and send a location of the APC within the target area based on the detection of the APC by the camera.

7. The docking system of claim 1, wherein the APC comprises a location communicator and wherein the camera is configured to monitor the APC by detecting at least the location communicator.

8. The docking system of claim 7, wherein the location communicator comprises a light source.

9. The docking system of claim 7, wherein the location communicator is configured to provide location information based on a characteristic of the location communicator.

10. A method of controlling an automatic swimming pool cleaner (APC), the method comprising using information from a camera on a dock of a docking system to control the APC.

11. The method of claim 10, further comprising monitoring the APC underwater using a camera on the dock of the docking system.

12. The method of claim 10, further comprising determining a location of the APC using data from the camera and communicating the location to the APC.

13. The method of claim 12, further comprising monitoring the APC by detecting a location communicator, and wherein determining the location of the APC is based on a characteristic of the location communicator.

14. The method of claim 10, further comprising obtaining non-visual information using a sensor of the docking system and controlling the APC based on both the non-visual information and the information from the camera.

15. The method of claim 14, wherein the non-visual information comprises oxidation-reduction potential information, pH information, temperature information, conductivity information, and/or salinity information.

16. A docking system for an automatic swimming pool cleaner (APC), the docking system comprising a camera configured to monitor a target area within a swimming pool or spa, wherein the docking system is configured to (i) identify a location of the APC within the target area based on a detection of the APC within the target area using the camera and (ii) send location information to the APC based on the detection using the camera.

17. The docking system of claim 16, wherein the docking station comprises a location communicator on the dock, and wherein the location communicator is configured to provide location information to the APC within a swimming pool or spa.

18. The docking system of claim 17, wherein the location communicator comprises a light source.

19. The docking system of claim 17, wherein the location communicator is configured to provide location information based on a characteristic of the location communicator.

20. The docking system of claim 16, wherein the APC comprises a location communicator, and wherein the camera is configured to monitor the APC by detecting at least the location communicator.
